(19) United States
(12) Patent Application Publication
(10) Pub. No.: US 2018/0275976 A1
(43) Pub. Date: Sep. 27, 2018

(54) LINK TIME OPTIMIZATION IN PRESENCE OF A LINKER SCRIPT USING PATH BASED RULES

(71) Applicant: Qualcomm Innovation Center, Inc., San Diego, CA (US)

(72) Inventors: Tobias Edler Von Koch, Austin, TX (US); Sergei Larin, Austin, TX (US); Shankar Kalpathi Easwaran, Austin, TX (US)

(21) Appl. No.: 15/711,595

(22) Filed: Sep. 21, 2017

Related U.S. Application Data
(60) Provisional application No. 62/475,019, filed on Mar. 22, 2017.

(51) Int. Cl. G06F 9/45

(52) U.S. Cl. CPC G06F 8/443

(57) ABSTRACT

A method for placing local symbols in an executable comprises determining an original output section for one or more symbols, storing original section metadata for each of the one or more symbols with intermediate representations of the one or more symbols, and determining an origin module identifier and storing origin module identifier metadata. The method comprises emitting each of the one or more symbols to one or more output sections based on the original section metadata and the origin module identifier metadata, extracting the original section metadata and origin module identifier metadata from the one or more symbols emitted to the one or more output sections, and overriding a name of a section with an original section name associated with the one or more symbols. The method comprises overriding a default origin name of the executable section with an origin module identifier associated with the one or more symbols.

### CLAIM OF PRIORITY UNDER 35 U.S.C. § 119

The present Application for Patent claims priority to Provisional Application No. 62/475,019 entitled “FAITHFUL MATCHING OF PATH-BASED LINKER SCRIPT RULES DURING LINK-TIME OPTIMIZATION” filed Mar. 22, 2017, and assigned to the assignee hereof and hereby expressly incorporated by reference herein.

### FIELD OF THE DISCLOSURE

The present disclosure relates generally to compilers that compile high-level code to machine code, and more specifically, to link time optimization.

### BACKGROUND

In general, a compiler is a computer software program that transforms high-level computer programming code, such as source code written in a human-readable language (e.g. C, C++), into lower-level assembly or machine code (e.g., binary). Compilers utilize various optimization techniques in order to improve the performance of the resulting executable. In general, optimization allows a program to be executed more rapidly or utilize fewer resources. Link time optimization (LTO) is a powerful compilation technique typically utilized in general computing environments, such desktop computers, that allows broadening of the optimization scope in programming languages that otherwise compile a program one file at a time. That is, the optimization scope can be broadened so that the compiler can compile and optimize more than one file at a time. LTO utilizes a computer program (i.e., a utility) known as a linker which links together multiple files of a source program, once optimized by the compiler, to a final executable comprising distinct sections of binary code.

A linker script is another utility used in conjunction with a linker, often in embedded application environments. It is used to express a fine degree of control over the final executable image and—namely—the particular sections thereof produced during the compilation (and optimization) process.

In the past, the use of linker scripts with LTO had been virtually incompatible. However, recent technological developments have provided systems and methods for using LTO in the presence of a linker script. However, such use of a linker script leads at times to a requirement for additional utilities and functions to further optimize execution of the linked code.

### SUMMARY

An aspect of the present disclosure provides a method for placing local symbols in an executable during link-time optimization of software code in the presence of a linker script. The method may comprise determining an original output section for one or more symbols and storing original section metadata for each of the one or more symbols in association with intermediate representations of the one or more symbols. The method may further comprise determining an origin module identifier that identifies a source file for each of the one or more symbols and storing origin module identifier metadata for each of the one or more symbols. Then, the method may comprise emitting each of the one or more symbols to one or more output sections based on the original section metadata and the origin module identifier metadata. The method may further comprise extracting the original section metadata and origin module identifier metadata from the one or more symbols emitted to the one or more output sections and overriding a name of a section with an original section name associated with the one or more symbols. The method may then comprise overriding a default origin name of the executable section with an origin module identifier associated with the one or more symbols.

Another aspect of the disclosure provides a computing device comprising a processor and a memory configured to execute a linker and a compiler, wherein the linker and compiler are configured to perform a method for placing local symbols in an executable during link-time optimization of software code in the presence of a linker script. The method may comprise determining an original output section for one or more symbols and storing original section metadata for each of the one or more symbols in association with intermediate representations of the one or more symbols. The method may further comprise determining an origin module identifier that identifies a source file for each of the one or more symbols and storing origin module identifier metadata for each of the one or more symbols. Then, the method may comprise emitting each of the one or more symbols to one or more output sections based on the original section metadata and the origin module identifier metadata. The method may further comprise extracting the original section metadata and origin module identifier metadata from the one or more symbols emitted to the one or more output sections and overriding a name of a section with an original section name associated with the one or more symbols. The method may then comprise overriding a default origin name of the executable section with an origin module identifier associated with the one or more symbols.

Yet another aspect of the disclosure provides a non-transitory, computer-readable storage medium configured to perform a method for placing local symbols in an executable during link-time optimization of software code in the presence of a linker script. The method may comprise determining an original output section for one or more symbols and storing original section metadata for each of the one or more symbols in association with intermediate representations of the one or more symbols. The method may further comprise determining an origin module identifier that identifies a source file for each of the one or more symbols and storing origin module identifier metadata for each of the one or more symbols. Then, the method may comprise emitting each of the one or more symbols to one or more output sections based on the original section metadata and the origin module identifier metadata. The method may further comprise extracting the original section metadata and origin module identifier metadata from the one or more symbols emitted to the one or more output sections and overriding a name of a section with an original section name associated with the one or more symbols. The method may then comprise overriding a default origin name of the executable section with an origin module identifier associated with the one or more symbols.

### BRIEF DESCRIPTION OF THE DRAWINGS

FIG. 1 shows a high-level view of an LTO tool flow in the presence of a linker script.

FIG. 2 shows the different types of compiled code produced by a compiler in a first compilation step of an LTO process.

FIG. 3 depicts how the output sections of an executable in conventional LTO might compare with output sections of an executable in the presence of a linker script.

FIG. 4 shows components of the LTO tool flow of FIG. 1, with depictions of additional subcomponents of the linker, compiler, and application program interfaces.

FIG. 5 is a timing diagram of a method as depicted in FIG. 4.

FIG. 6 illustrates an example of how local symbols in a linker script may be placed in an executable object according to aspects of the present disclosure, respectively.

FIG. 7 is a logical block diagram depicting components that may implement a method for correct placement of symbols in accordance with the present disclosure.

FIG. 8 is a flowchart of a method in accordance with an embodiment of the present disclosure.

FIG. 9 is a hardware diagram of a computing device that may implement aspects of the present disclosure.

### DETAILED DESCRIPTION

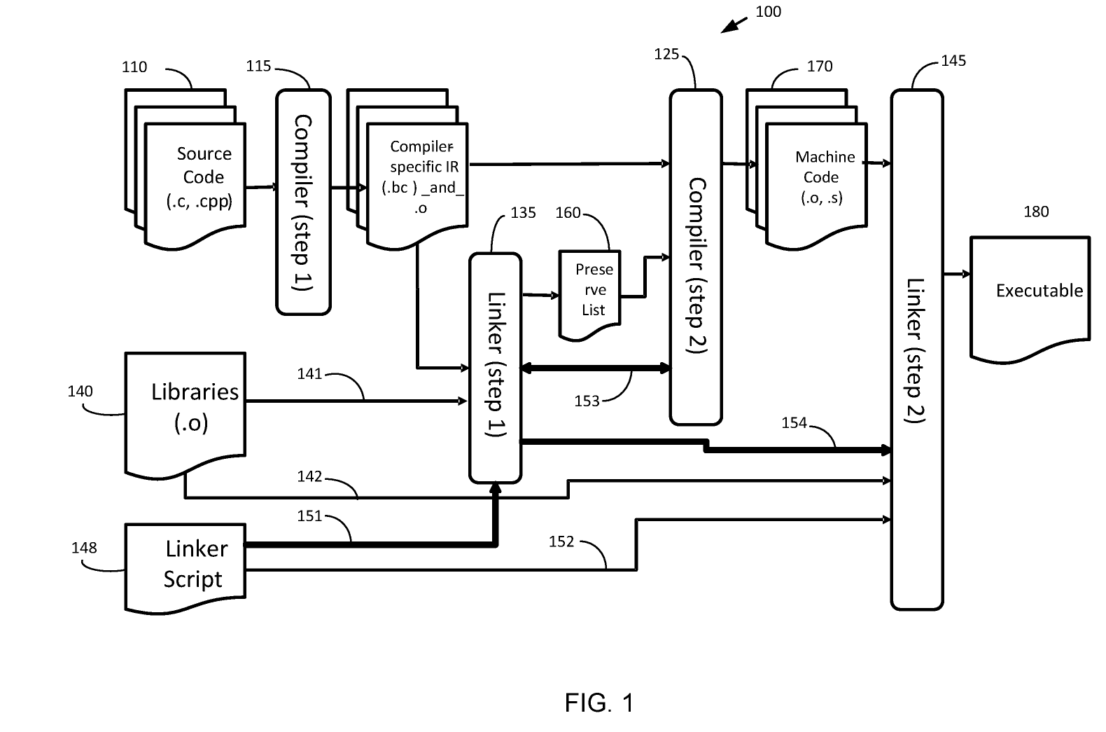

LTO is a highly desirable optimization methodology because it is powerful and works well in very demanding general purpose development environments. Until recently, LTO had not often been used in the presence of linker scripts because the two techniques had inherent conflicts that made them incompatible. However, new approaches described in co-pending and commonly owned U.S. patent application Ser. Nos. 15/273,527 and 15/273,511, which are incorporated herein by reference, allow for the use of LTO in the presence of a linker script. Aspects of the methods, interfaces, and solutions that enable the use of LTO in the presence of a linker script are described herein with reference to FIG. 1.

FIG. 1 is a logical block diagram depicting several aspects of an exemplary embodiment. The diagram depicts a process 100 of compiling and linking received source code to an executable in an LTO build flow in the presence of a linker script. The term “executable” is used throughout this disclosure to describe an final executable image of code that may be executed on a processor, as known in the art. FIG. 1 is a logical diagram and should not be construed to be a hardware diagram. The logical blocks in FIG. 1 may be implemented in software, hardware, firmware, or a combination of hardware, software, and firmware. The process outlined in FIG. 1 may be implemented by a compiler and a linker that interact with each other and with versions of code at particular steps in the process. The compiler and linker may each be thought of as single software programs broken up into steps to show inputs, outputs, and the timing of communication between each program. For ease of reference, a single compiler is depicted as operating at Compiler (step 1) 115 and Compiler (step 2) 125 with Linker (step 1) 135 and Linker (step 2) 145. Throughout the disclosure, the compiler may be referred to interchangeably at its first and second steps as “first/second step of the compiler,” “first/second stage of the compilation,” “the compiler at step one/two,” or “the compiler at stage one/two.” The linker may be referred to with similar terminology and reference to the first or second steps or stages.

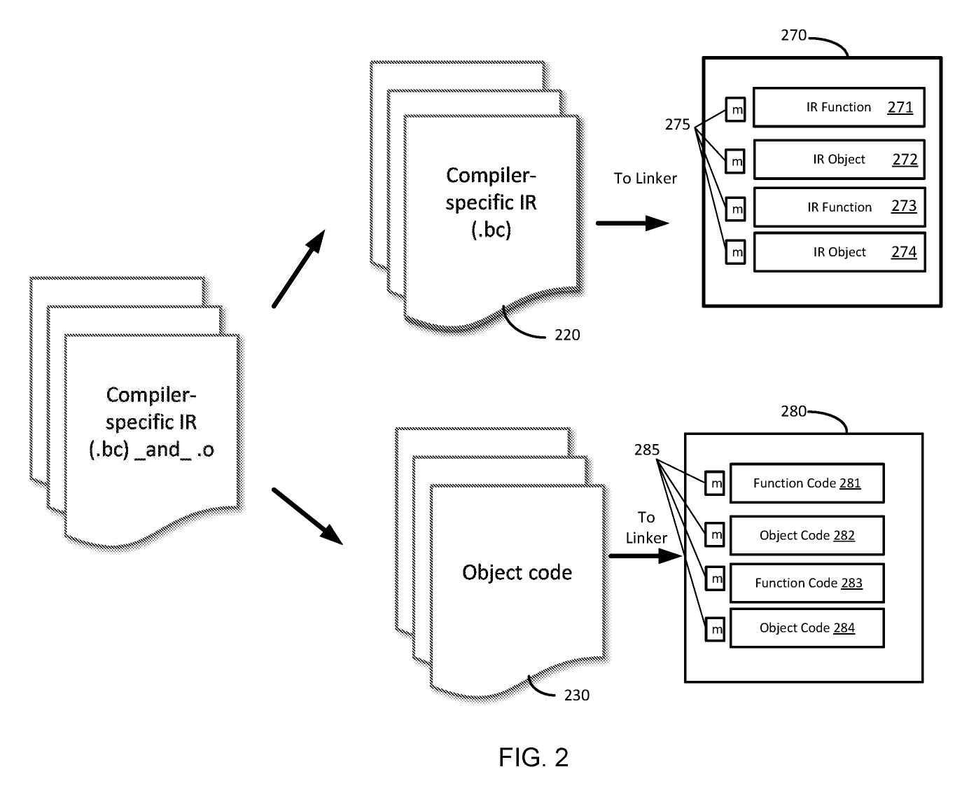

Compiler (step 1) 115 first receives source code 110 of a program. As shown, the source code 110 has example file extensions .c and .cpp, (indicating source code written in C or C++, respectively), but source code may be received in other languages, or may be in a human-readable assembly language. Compiler (step 1) 115 then compiles the source code 110 into two types of files, the first of which being compiler-specific and platform independent intermediate representations (IR, also referred to as internal representation), designated with a .bc (bit code) file extension, and the second of which being platform specific object code (designated with a .o file extension). Compiler (step 1) 115 performs optimizations that are possible at the level of local scope (i.e., one file or one library) and do not yet require information about the global scope (i.e., a whole program). Most optimizations may be performed later, at Compiler (step 2) 125. FIG. 2 shows how these two types of files compiled at Compiler (step 1) 115 are distinct, and turning now to a discussion of their differences will facilitate an understanding of the present disclosure. While discussing the subsequent figures, reference may still be made to the components in FIG. 1.

FIG. 1 also shows a linker script 148 in communication with Linker 135, 145 at interfaces 151 and 152, respectively. A linker script allows a user (i.e., a developer) to explicitly describe the memory layout of the executable image produced by the linker. This is a facility often used for embedded applications where users want to exert a fine degree of control in order to support techniques such as compression, tightly coupled memory (TCM) placement, and dynamic heap reclamation that are applied to some, but not all, or the input data and code (historically called “text”).

The steps that facilitate the linker script support are depicted as interfaces 151, 153, and 154, each of which are highlighted in bold lines. Each of these steps represent one or more interfaces, communication channels, and/or instructions that allow the linker script to be respected with the LTO tool flow. In particular, the linker script 148 may interact with Linker (step 1) 135 through interface 151, Linker (step 1) 135 may communicate with Compiler (step 2) 125 through interface 153, and Linker (step 1) 135 may communicate with Linker (step 2) 145 through interface 154. The interface 153 comprises an application program interface (API) and allows several pertinent aspects of the solution to be implemented, which will be described in detail through the disclosure. Linker (step 1) 135 generates a “preserve list” 160 to be used by Compiler (step 2) 125, which is also facilitated by the API 153. The final steps in the LTO flow 100 depicted are that Compiler (step 2) 125 compiles all the IR and object files into machine code 170, and Linker (step 2) 145 links compiled code from multiple sources to a final executable 180.

Each object file, whether it comes from source code that has been compiled in Compiler (step 1) 115, or from existing object libraries 140, includes global, local and common symbols that represent individual named memory objects. The term “symbols” referred to herein is a blanket term that encompasses both functions (i.e., a sequence of instructions in code that executes) and objects (i.e., a declared variable). After this first step of compilation 125, the rest of the compilation process is strongly dependent on what symbols are used and where they are used. Dependencies of symbols will be discussed throughout the disclosure, but in particular, each symbol is destined to a particular section of the executable. The system depicted allows Linker (step 1) 135 to parse (or read) the compiler-specific IR to be able to tell what symbols those particular IR files include, or whether the symbols are local, global, or common, so that the linker can assign output sections early on in the linking process.

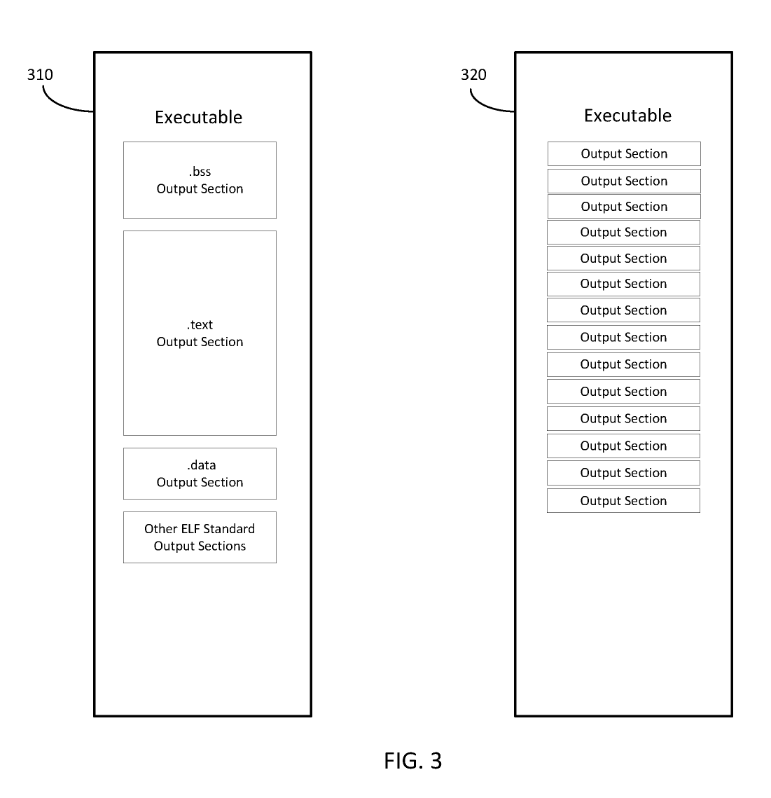

FIG. 3 conceptually illustrates an output format of an executable 310 in traditional LTO without a linker script and an output format of an executable 320 with a linker script, though the examples depicted are greatly simplified for the purposes of illustration. An executable 310 in traditional LTO may have a number of predefined sections, such as a .bss section for uninitialized objects, and a .text section for executable code, and a .data section for memory objects. One standard output format of an executable is known as ELF (Extensible and Linkable Format), and can be used here for illustration purposes on how a typical executable produced by a linker in traditional LTO, such as executable 310, may have around one or two dozen sections. An executable that is produced as the result of linking under direction of a custom linker script, such as executable 320, has sections that are specifically defined by the linker script. These sections likely have different attributes than a typical executable produced by linking in general. Although the linker script-produced executable 320 does not necessarily have to have more sections, in many implementations, the linker script-produced executable 320 will have more sections, sometimes numbering in the thousands. This is because, as will be described later, each function and object of a source code file may be placed in its own individual section as part of the present solution. Therefore, executable 320 is depicted as having many more individual output sections than executable 310.

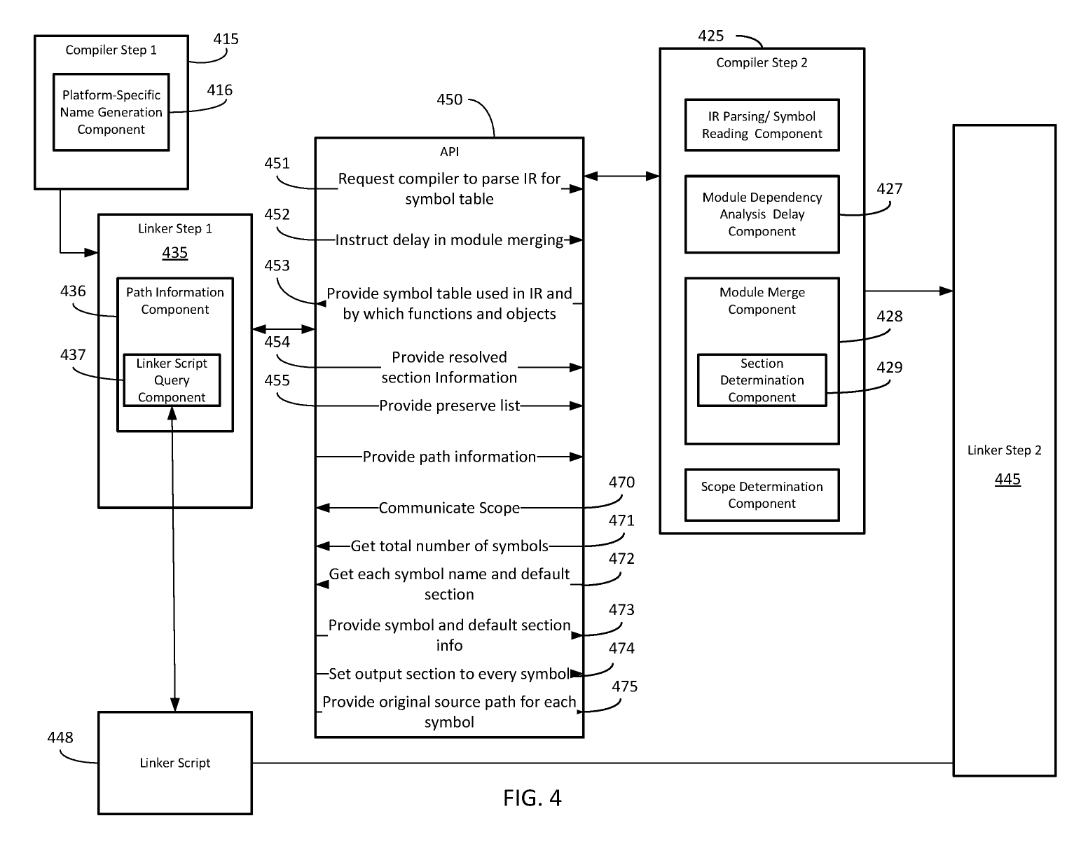

FIG. 4 is a logical block diagram showing several components of the LTO tool flow of FIG. 1 in greater detail. The components depicted in FIG. 4 are not intended to be a hardware diagram, but are intended to show logical steps and connections implemented in software and/or hardware. Certain components that are present in FIG. 1 are omitted from FIG. 4 for the sake of clarity. In one aspect of the disclosure, the solution changes the process of compiler IR code generation to include platform-specific name generation for each function and object destined for LTO. Compiler (step 1) 415 comprises a platform-specific name generation component 416. In existing compilation processes, certain flags are provided in source code (more particularly, in the makefile) for particular functions and objects. Certain types of flags, for example, indicate how a particular function should be optimized more for speed or another one more for size. Other types of flags include “-f-function-sections” flags for functions and “-f-data-sections” for objects. These flags allow the assignment of functions and objects to certain output sections. If there is no such flag, all functions will, for example, be placed in the output section “.txt.” However, if a function is flagged with -f-function-section, then the function will be placed in its own specific section, named “.txt.name_of_the_function,” for example. The platform-specific name generation results in a particular function or section being named in this manner. The flagging of functions and objects is an existing capability, but it can be used for implementing aspects of the present disclosure. It is one way that each function and object will be put in its own individual section. A compiler itself can delete sections, but this feature of platform-specific name generation is helpful because the linker itself deals with sections, and has the ability to delete sections, but cannot delete functions or objects. As a result of flagging each function and object, each section now has its own name, and may be dealt with more easily by the linker as well as the compiler. Metadata is used (by the compiler) to store the these flags and other information in association with each symbol. It is contemplated that other ways may be used to name individual sections without departing from the scope or the present disclosure

Turning back to FIG. 2, which shows how the Compiler (step 1) produces both IR 220 and object code 230, FIG. 2 also illustrates how individual functions and objects may be seen by the linker. IR compilation lines 270 are shown with individual IR functions 271, 273 and individual objects 272, 274 in their own sections. Metadata 275, which is depicted with a small “m,” is associated with each function and object, and is used to store information about each. Similarly, object code compilation lines show function code 281 and 283, and object code 282 and 284. Metadata 285 is associated with each function and object in object code as well.

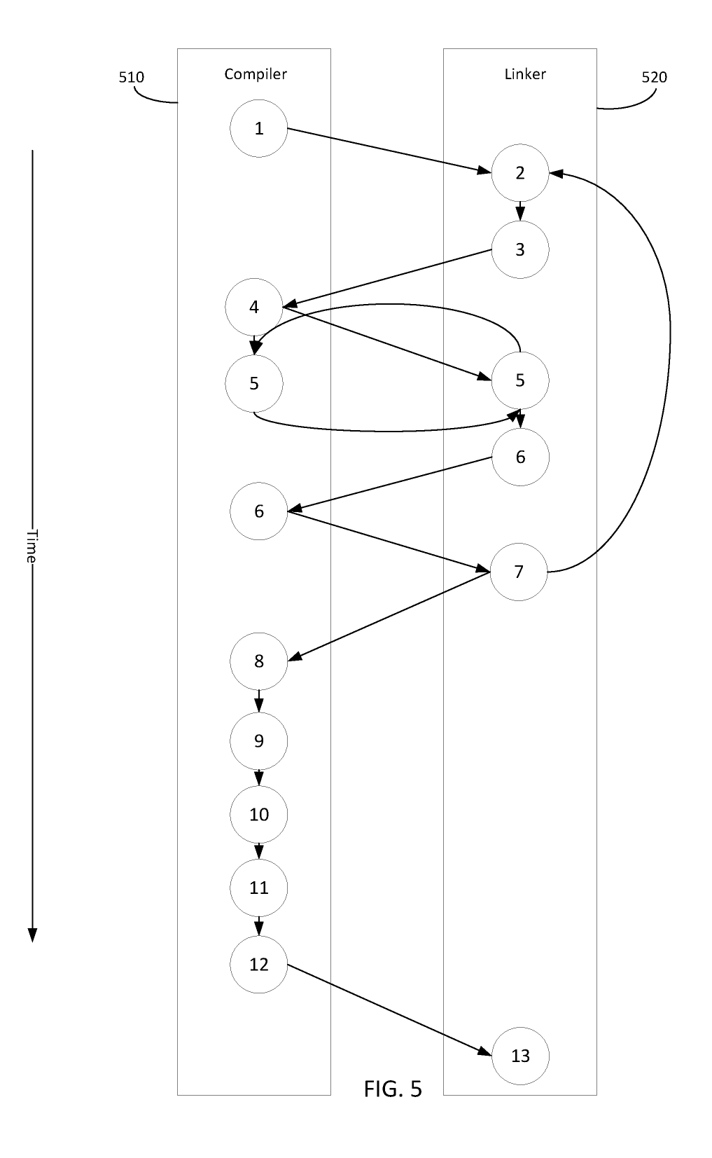

Referring again to FIG. 4, the diagram shows how the LTO tool flow facilitates LTO in the presence of a linker script. An API 450 facilitates communication between the linker at step one 435 and Compiler (step 2) 425. Within the API 450 are several process or method steps, depicted as flowing from either left to right (signifying a communication or request from the linker to compiler) or right to left (signifying a communication or request from compiler to linker). The steps are also depicted in a timing diagram in FIG. 5 to more clearly show the sequence of events between the linker and compiler as depicted here in FIG. 4, where temporal execution of the steps is ordered from top to bottom of FIG. 5. Each of these process or method steps may be implemented in an algorithm in the API 450. Though the process or method steps are depicted in a particular order from top to bottom, they are not necessarily implemented in the particular order, and may be implemented simultaneously or in an overlapping manner in actuality.

Depicted within Linker (step 1) 435 and Compiler (step 2) 425 are various logical block components for implementing aspects of the system. In particular, they implement many of the communications and requests depicted in the API 450, as well as other features of the solution. The blocks are logical and are not to be construed as a hardware diagram, and may be implemented by software alone, hardware alone, or a combination of hardware and software.

One aspect of the API 450 is that it allows Linker (step 1) 435 to request that the compiler parse its own IR in order to identify the symbols contained within the IR and def-use (definition and use) relationships between them at step 451. That is, code contained within IR may contain both definitions and uses, but until that IR is parsed, the compiler and linker cannot tell if there are any functions or sections that are not going to be used and could be eliminated. In another aspect, the system API 450 allows the compiler to delay module dependency analysis at step 452. Modules are how blocks of code that exist within a particular file are referred to in relation to a compiler and roughly correspond to source code files. During traditional LTO, the linker sends the compiler multiple code modules to be accumulated (or “merged”) into the single optimization scope. In traditional LTO, the sending of the multiple code modules to the compiler for merging is beneficial and allows for greater code optimization by the compiler. However, in the system described herein, the compiler sends the linker parsed IR with symbol information and dependency information about the symbols with each module that is parsed. If dependency analysis were to be performed by the compiler incrementally as modules are received from the linker, the linker would receive dependency information back incrementally as well, which would be incomplete.

As seen in the API 450, at step 453, Compiler (step 2) 425 provides the requested symbol table back to Linker (step 1) 435, which is accomplished by the IR parsing/symbol reading component 326. If the dependency analysis is performed by the compiler as each module is received, then Compiler (step 2) 425 cannot tell Linker (step 1) 435 what symbols are used in IR for the whole scope. Therefore, the present solution provides a module dependency analysis delay component 427, which accumulates pointers to modules in memory in Compiler (step 2) 425 until all of them are available. Once they are all available, then Compiler (step 2) 425 communicates the symbol resolution (i.e., tells the linker what symbols are used where) at step 453. After that, the module merge component 428 of the compiler merges modules.

An additional drawback to analyzing the dependency of modules incrementally (i.e., as they come in), is that path information, which tells Linker (step 2) 445 in what output section to place certain objects and functions, is also lost. For example, when Linker (step 1) 435 receives files, it receives along with it default path information that says what directory the files come from, and what output sections they should ultimately end up in. As stated previously, there may be default instructions in the linker that specify which files should go in which sections, but in the presence of a linker script, the linker script may also contain different rules that specify particular files to go in different output sections than they otherwise would. In traditional LTO, when the linker provides files to the compiler for optimization, the compiler, as previously discussed, typically takes the modules and merges them for compilation. In this merging process, the path information (also known as “source path” information) of where the content of those files should ultimately end up in the output section, is lost.

In the present solution, Linker (step 1) 435 comprises a path information component 436, which has several responsibilities. For one, it memorizes and keeps a list (i.e., records the original source path for each symbol in association with its source module) of the final output section destination for each section. This recording of the original source path for each symbol is necessary for the proper treatment of common symbols at the end of the linking process, which will be discussed in further detail. Additionally, the path information component queries the linker script 448, via a linker script query component 437, to see whether the linker script specifies a particular output section other than a default one.

The API 450 of the present solution also allows the linker to correctly place all sections in the final executable in the present of a linker script. As shown, at step 470, the API allows Compiler (step 2) 425 to communicate the scope of the optimization to Linker (step 1) 435. Then the API 450, allows the linker to “get,” at step 471, the total number of symbols per module that were gathered at the previous step and a way to “get,” each symbol name and default section information at step 472 and 473. The linker receives the symbol information along with the source path at step 474 to determine the output section for each symbols based on the provided linker script 448. Finally, the linker provides the original source path for each symbol at step 475, in order to ensure that common symbols are treated properly. By performing these steps, the linker ultimately knows, from the combination of symbols, the source path, and the linker script, where to properly place output sections in the final executable.

Linker (step 1) 435 not only provides the information it has about symbols, sections, and path information to Linker (step 2) 445, but also resolved section information to Compiler (step 2) 425, as illustrated in the API 450 at step 454. The compiler keeps this resolved section information along with each object throughout the compilation process.

Additionally, Linker (step 1) 435 provides a preserve list (e.g., preserve list 160 of FIG. 1) at step 455. A challenge to optimization is presented in an LTO flow in the presence of a linker script because it is the responsibility of Linker (step 1) 435 to not only look at the files in the current scope, but to also look at the files outside of that scope to determine what symbols are used in other scopes (to ultimately create the final executable). In existing compilation processes, and in the current implementation, Linker (step 1) 135 gathers a list of these knowable symbols, which is known as a preserve list 160, and passes it on to Compiler (step 2) 125. This list informs Compiler (step 2) 125 which symbols can be discarded, and consequently, which code can be deleted. When a linker script is present, as in the implementations shown, the linker script 448 also communicates with Linker (step 1) 435. Both the content of the IR and the linker script are highly influential on the preserve list 160. Because the IR is treated conservatively, very few symbols are left off of the preserve list 160 in case an IR file might need them.

As previously mentioned, one of the tasks a compiler does during compilation in LTO (at Compiler (step 2) is to merge all of the modules together before sending them back to Linker (step 2). Because of the API 450 and the steps of communication facilitated therethrough, Compiler (step 2) 425 is able to gather all functions and objects that might be visible to the linker at the final link stage (at Linker (step two) 445) and log default output section information that is stored in the IR. This gathering of all functions and objects may be done on the level of each individual module so that the module-to-symbol relationship is not lost. Then, Compiler (step 2) 425 merges all modules into a single optimization scope via the module merge component 428. and internalizes symbols with respect to available output section information and the preserve list. This internalization produces different results from existing localization processes.

As a result of the additional communication between the linker and compiler via the APIs, compilation can commence with the use of the additional output section information. In FIG. 4, this is depicted as the section determination component 429 within the module merge component 428, to illustrate that the use of section information by the compiler takes place during the module merge process. Because the compiler now knows in what output sections certain functions and objects will ultimately be placed, the compiler can use that information to both restrict and facilitate various compilation decisions. It is contemplated that, in general, that different output sections can be treated differently. When the compiler has this output section information, the compiler can be much more effective at reducing the size of compiler code without an impact on performance. Additionally, more input from a user may be solicited via a linker script to assign various properties to various output sections. These properties might include “hot or cold,” performance vs size tradeoff, or even a “firewall requirement that no control flow transfer is possible between certain output sections. Additional input from a user can also allow for improved security features.

At the end of the compilation process, the compiler materializes local variables and functions to their intended output sections, and leaves global and common objects to be placed by Linker (step 2) 445. Linker (step 2) 445 also conducts the final assignment of sections and a final step of garbage collection, resulting in the final executable image.

The overall optimization process of the present disclosure as described in relation to various components of the linker, compiler, and API in FIG. 4 may also be understood by describing the process in terms of timing. FIG. 5 shows a timing diagram with simple linear representations of a compiler 510 and linker 520, with steps 1-13 of the process shown taking place in the linker, compiler, or both in relation to time. The compiler 510 and linker 520 are not depicted as having two separate stages in the way that they are depicted in FIG. 4, but it is to be understood that the functionality described in relation to FIG. 5 is the same as that described in relation to FIG. 4. As such, it is also to be understood that the API (depicted in FIG. 4, but not depicted in FIG. 5) enables the communication between the compiler 510 and the linker 520.

Turning now to each of the steps in FIG.5, at step 1, the compiler 510 receives a selection of source files (e.g., .c, .cpp, etc.). Based on the makefile of the source code, some of the source files are initially compiled to IR (.bc) and others to object code (.o). Then, according to the method of the present disclosure, for each symbol (i.e., function or object) that is destined to be compiled to IR, the compiler adds metadata containing the symbol's default section assignment.

Next, at step 2, linking begins in the linker 520. The linker 520 receives a selection of compiled files (both in IR and object code) as well as a linker script. For each symbol that is in object code, both their origin path and their output section is recorded, and their dependency information is updated. For each IR file, the origin path is also recorded, but because their output sections and dependencies cannot be read by the linker, the linker requests the compiler to parse the IR. However, before sending the IR and the request back to the compiler, the linker, at step 3, reads the IR file into memory.

Once the linker sends the IR and parsing request to the compiler (as depicted by the arrow between steps 3 and 4), an aspect of the present disclosure is that the compiler, at step 4, receives a memory buffer containing the content of the .bc file (the IR) and reads it as a compiler module. The compiler them parses the content of the module and records information about each symbol. Included in this recorded symbol information is the default section assignment that was initially recorded in the metadata for each symbol in step 1. Another aspect of the disclosure is that dependencies are recorded for each symbol that exists in the IR module. Then, the module is merged with any previously read IR modules. Once parsing is complete, the compiler informs the linker that it is complete, as represented by the arrow between steps 4 and 5. The requesting, parsing, recording, merging, and communicating back to the linker may be facilitated in whole or in part by the API between the compiler 510 and the linker 520.

Step 5 is depicted as taking place at both the compiler 510 and the linker 520. At step 5, the linker 520 actually receives the symbol information that has been parsed and recorded from the compiler 510. Step 6 is also depicted as occurring at both the linker 520 and compiler 510. At step 6, in the linker 520, the linker uses the default section information for all the symbols in IR that were received in step 5. Then, using the linker script, the linker 520 is able to assign output sections to the symbols that were in IR and then inform the compiler about that output section assignment (depicted at compiler 510 step 6). This step allows the fine control of output sections according to the linker script that would not have been possible if the linker 520 did not have the symbol information for IR files. Steps 2-6 may be repeated by the linker 520 and the compiler 510 until all files of the source code are processed.

Once all input files have been processed, and all symbols for both object code and IR have been accounted for, a full dependency graph between all the symbols is available, and the linker can generate a preserve list, which it does at step 7. Then, the linker 520 sends the preserve list to the compiler (as depicted by the arrow between steps 7 and 8). Then, at step 8, at the compiler 510, all global symbols that are not in the preserve list are localized to the current module. In prior approaches, symbols could be localized, but in the present disclosure, the preserve list has full symbol information and a dependency graph that allows more aggressive optimizations by the compiler 510.

Next, at step 9, the compiler 520 performs global optimization to the whole file scope. These optimizations are performed in view of the assigned output sections for each symbol. If, for some reason, a normal optimization that would be performed by the compiler 520 at this stage would violate the intended output section assignment as dictated by the linker script, the optimization is not performed, which is one advantage of the present disclosure. An additional advantage to the compiler 510 having all the output section assignments at this stage is that additional optimizations become available because of the output section information.

Next, at step 10, machine specific code generation is performed. During this step, the compiler assigns every symbol to a specific section, as required by ELF standards. At step 11, several steps pertinent to the present disclosure take place in order to ensure the correct placement of local and global symbols, which will be described in greater detail shortly. At step 12, one or more object files are generated by the compiler 510. These object files are then passed to the linker, as represented by the arrow between steps 12 and 13. At step 13, the final linking starts and results in the final executable image being created.

In the linker script with LTO tool flow described herein, the use of resolved output section information allows the linker script to be used during both classical and IPO (Inter Procedural Optimizations). This resolved section information allows additional IPO optimizations that are not possible without it.

Aspects of the present disclosure relate to the placement of global and local objects in a final executable. These steps generally take place in step 11 in the flow described in FIG. 5. Due to certain aspects of the described system that allows a LTO to be used in the presence of a linker script, local objects may get placed in an incorrect output section of the final executable without the steps described herein. In particular, certain previous implementations of the system result in local objects being placed at the end of a section rather than within the section. Such incorrect placement violates path-based rules that are supposed to match all input sections from files in a given path. It also violates assumptions made by a linker script developer, who would expect certain local objects to be placed relative to boundaries introduced by marker symbols. If local objects are not placed where the developer expects them to be, the executable code may suffer from both correctness and performance issues. For example, certain post-processing applications may not work correctly, or accesses of memory locations may be slower than expected.

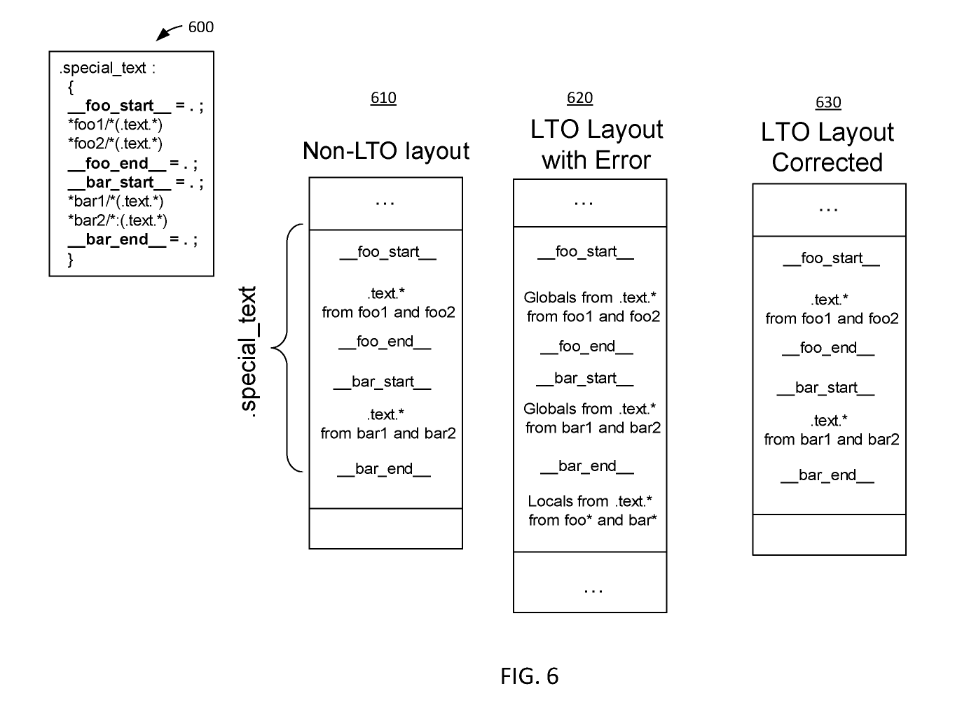

FIG. 6 shows how global and local objects may be placed in output sections with and without the solutions of the present disclosure. An excerpt from a linker script 600 describes the intended layout of symbols within a particular output section known as “.special_text.” The layout includes markers, which in the excerpt 600 are “_foo_start_” and “_foo_end_” and “_bar_start_” and “_bar_end_.” Such markers may be put in place by developers for various reasons, including identifying addresses in memory. The excerpt 800 specifies that symbols “foo1” and “foo2” should be placed within the markers _foo_start_{—} and _foo_end_, and that the symbols “bar1” and “bar2” should be placed within the markers _bar_start_{—} and _bar_end_. An first example of an executable 610 shows how the output section .special_text would be arranged according to this linker script without LTO. This layout is correct according to the linker script instructions.

A second example of an executable 620 illustrates a problem with the layout of the executable that can occur in certain implementations of LTO in the presence of a linker script. Namely, in this layout, the global symbols are placed correctly, but the local symbols are not. As shown, the global symbols (“globals”) from .text* foo1 and foo2 are placed between the markers _foo_start_{—} and _foo_end_, and the globals from .text* bar1 and bar2 are placed between the markers _bar_start_ and _bar_end_. However, the local symbols (“locals”) from .text* from foo* and bar* that were written in the linker script to be in the .special_text section were placed at the end, after the _bar_end_{—} marker.

An aspect of the present disclosure provides a method to ensure that the global and local symbols get placed in the proper sections, in proper relation to the markers, when LTO is used in the presence of a linker script. Throughout the disclosure this aspect may be referred to as “a method for correct placement of local symbols.” The third example of an executable 630 shows the resulting correct layout from the method for correct placement of local symbols, which is the same layout as the first example 610. The method by which the correct placement is ensured in the third example 630 will be described in detail presently.

In order to implement the correct placement of local and global symbols, one aspect of the method provides additional tracking of a symbol's origin within the compiler, and another aspect provides linker support to process that information. Another aspect provides new metadata; namely, “Original Section” metadata and “Origin Module Identifier” metadata. These two pieces of metadata are included alongside the “Resolved Section” metadata previously described (in step 454 of FIG. 4).

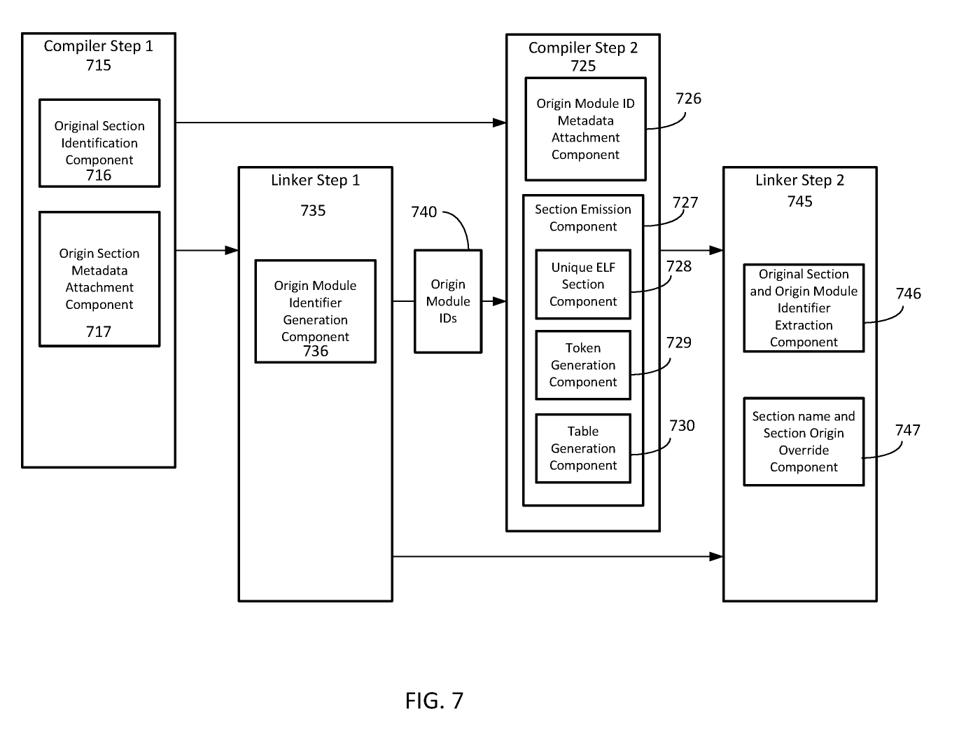

The method for correct placement of local symbols of symbols may be understood with reference to FIG. 7. FIG. 7 is a diagram illustrating portions of the linker script and LTO tool flows illustrated in FIGS. 1 and 4, omitting certain aspects previously described for clarity in illustrating the aspects presently described. To assign the proper metadata, the Compiler at step 1 715 first determines the “default” output section for each symbol based on three things: 1) the compiler's command line flags (e.g., -ffunction-sections/-fdata-sections), 2) the symbols' source code annotations (e.g., _attribute_((section( ))), and 3) conventions in the target backend for emitting to certain output sections (e.g., read-only data is emitted to output section “.rodata”). This may be implemented by the Original Section Identification Component 716. These three pieces of information for a given symbol allow the compiler to compute the “Original Section” of that symbol. Then, this original section information is stored as metadata in the IR by an Original Section Metadata Attachment Component 717 in Compiler Step 1 717. As illustrated in FIG. 2, the metadata 275 is associated with IR symbols 271-274; this metadata includes the original section information.

Next, the Linker at step 1 735 computes a unique Origin Module Identifier for each IR input file. This may be implemented by an Origin Module Identifier Generation Component 736 Each unique Module Identifier may comprise one or more of a filename and an internal numeric ID, or an archive name and filename combination. In embodiments, the Module Identifier may be implemented by any kind of numeric or alphanumeric identifier, as long as it is unique to a particular IR file. Then, the Linker at step 1 735 may communicate the Origin Module Identifiers 740 for each IR input file to the Compiler step 2 725. In the Compiler step 2, the Origin Module ID is attached to each IR input file as metadata via the Origin Module ID Metadata Attachment Component 726. As previously discussed and shown in FIGS. 1 and 4, several other pieces of information are also communicated from the Linker step 1 135 to the Compiler step 2 125, including the preserve list and the resolved output section for each symbol. The presence of each of these pieces of information enables the compiler to respect and leverage the directives of the linker script during optimization (in Compiler Step 2 725) and, later on, enables the linker to perform proper symbol resolution (in Linker Step 2 745).

Next, the method of the present disclosure provides steps for optimization and code generation at Compiler step 2 725. As previously discussed, the Compiler step 2 725 merges IR input files into a single IR module for optimization (see Module Merge Component 428 in FIG. 4). Prior to merging these IR input files, though, the Compiler attaches another piece of metadata—the Origin Module Identifier metadata (computed from each symbol's IR file and communicated to the Compiler)—to each symbol via the Metadata Attachment Component 726. As a result, the symbols, prior to the merging of their files, now have two new pieces of metadata: the Origin Section Metadata added previously, and the Origin Module Identifier added at Compiler step 2 725. With this metadata now added to each symbol, the Compiler at step 2 725 can merge modules and perform optimizations while respecting boundaries imposed by resolved sections. Optimization passes often modify symbols in some way, such as by changing functions or variables, or deleting or replacing them. However, in the method of the present disclosure, the Compiler at step 2 725 also ensures that the metadata associated with each symbol, which includes Resolved Section, Original Section, and Origin Module Identifier metadata, is not deleted during optimization and remains intact throughout the process.

During code generation, the Compiler step 2 725 may emit global and local symbols to their correct section using one or more methods in accordance with the present disclosure. In particular, the present disclosure provides two possible methods for the emission of global symbols, one of which is also suitable for the emission of local symbols. Either of these methods may be implemented by the Section Emission Component 727. The first possible method for the emission of global symbols (but not local) is that the Section Emission Component 727 emits each global symbol to its original section. Sometimes global symbols have Original Sections that are not unique to the symbol. This could occur because an explicit output section was supplied by the developer using the source code annotation “_attribute_((section( ))” or because the symbol originated from a file that was compiled without -ffunction-sections/-fdata-sections. When this happens, the Compiler may perform steps to ensure that symbols of this kind (those having Original Sections not unique to the symbol) that originate from different source files are not emitted to the same ELF section ID in the output file. The compiler can do this, according to this first method, by emitting the global symbols to a unique ELF section of the required name per the source file, or a unique ELF section of the required name per symbol. The emission may be implemented by the Unique ELF Section Component 728.

The first method described solves a problem that occurred in previous implementations. The problem was that global symbols with non-unique sections might be matched by different rules in the linker script. If they shared an identical section in the output file, the linker would not be able to separate them. Take, for example, an instance in which Input1.o has a global symbol named “foo” with Original Section .text, and Input2.o has a global symbol named “bar” with Original Section .text. These two inputs have different symbols but the same (i.e., not unique) Original Section. The linker script may have “.output_section 1: {Input1.o(.text)} .output_section_2 {Input2.o(text)}.” If in Compiler step 2, Input1.o and Input2.o are merged, and then both foo and bar are emitted into the same .text section, the linker cannot place foo in .output_section_1 and bar in .output_section_2, because the linker can never split input sections. By emitting unique sections, one .text containing foo and one .text containing bar, the linker can then place them in the correct output sections based on the linker script.

The Section Emission Component 727 may emit the both global and local symbols to the proper section via a second method. This second method is the only method of the present disclosure that allows for the correct placement of local symbols, whereas either the first or second method may be used to correctly emit global symbols. In this second method, each global and local symbol is emitted in a way that communicates to the linker both 1) the symbol's Original Section and 2) its Origin Module Identifier. This method itself can be accomplished in one of two ways. First, the Compiler can emit each symbol to a section whose name contains both the symbol's Original Section and Origin Module Identifier separated by a token known to the linker, such as “OriginalSection̂̂OriginModuleID.” As shown, the Section Emission Component 727 may include a Token Generation Component 729. Alternatively, each global and local symbol can be emitted by 1) emitting it to a unique ELF section whose name is the Original Section name, per the input file, and 2) emitting a special section that contains a table with a mapping from ELF section IDs to Origin Module Identifier whose format is understood by the linker. The Section Emission Component 727 may therefore include a Table Generation Component 730.

Next, at the Linker step 2, 745 the output executable file is linked. The Linker step 2 745 loads the ELF output file produced (i.e., optimized and generated) by the Compiler at step 2 725. During loading, if the linker encounters a section containing local symbols, the linker extracts both the Original Section Metadata and the Origin Module Identifier Metadata via the Origin Section and Origin Module Identifier Extraction Component 746 from the output sections produced by the Compiler at step 2 through one of the above-described methods. That is, it may use the first method comprising emitting global and local symbols to a unique ELF section and emitting the special section with the table and mapping, or the second method utilizing the section name and a token.)

Then, once the linker extracts the Original Section and Origin Module Identifier, the linker overrides the section's name (that was generated by the Compiler) with the Original Section name. Then the linker overrides the section's file origin with the Origin Module Identifier in the linker's internal data structures. so as to “pretend” that the given section was actually loaded from the Origin Module. This may be implemented by a Section Name and Section Origin Override Component 747. Once the section name and section origin (for each section with one or more symbols in it) have been overridden with the symbols' Original Section and Original Module Identifier, the linker script can be processed by the linker and the sections can be matched according to the linker's normal rules.

The method of the present disclosure ensures correctness of symbol placement in several scenarios where it might otherwise be incorrect. By emitting symbols according to their Original Section and Origin Module Identifier, rather than the output section that the compiler would ordinarily choose in Compiler step 2, the LTO with linker script system can support the mixing of symbols from source files compiled 1) with and without -ffunction-sections, 2) with a mix of various optimization levels, and 3) other compiler options that result in a change of output section (e.g., -G0, -G8, etc.).

A potential complication to the method for correct local symbol placement of the present disclosure is that some LTO optimizations apply changes to the IR that make a symbol's Original Section assignment invalid. That is, the Original Section metadata may not be applicable after certain LTO optimizations to the IR. For example, a variable placed in the output section “.bss” may receive a non-zero initializer during LTO. To deal with such a circumstance, the method for correct symbol placement may include either a conservative or aggressive remediation technique. The conservative option includes not permitting optimizations that would invalidate a symbol's Original Section assignment during LTO. Compiler optimizations would need to be modified to become aware of their possible effect on the validity of a symbol's Original Section. The aggressive option includes computing a new “Original” Section based on the symbols from the previous Original Section. In this option, the use of -fdata-sections and similar flags is inferred from the Original Section name.

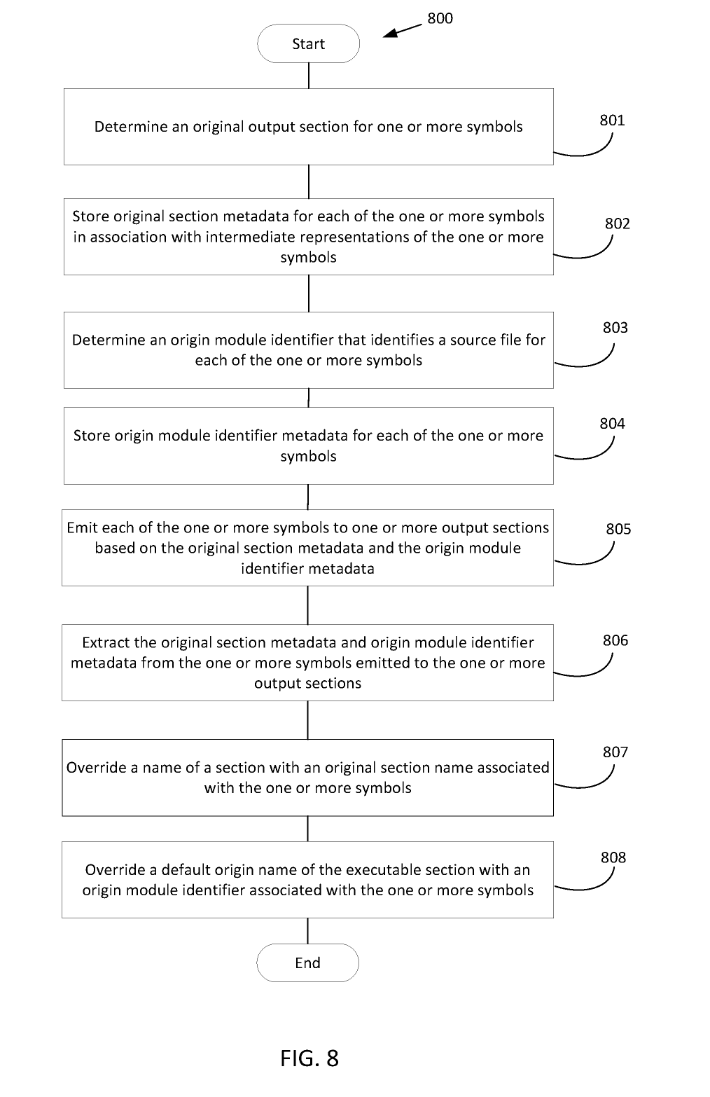

FIG. 8 is a flowchart which may be traversed to implement a method 800 of code optimization. The method may first include, at block 801 determining an original output section for one or more symbols. Then, at block 802, the method may include storing original section metadata for each of the one or more symbols in association with intermediate representations of the one or more symbols. At block 803 the method may include determining an origin module identifier that identifies a source file for each of the one or more symbols. The method may then include, at block 804, storing origin module identifier metadata for each of the one or more symbols. The method may then include, at block 805, emitting each of the one or more symbols to one or more output sections based on the original section metadata and the origin module identifier metadata. At block 806, the method may further comprise extracting the original section metadata and origin module identifier metadata from the one or more symbols emitted to the one or more output sections. Then, at block 807, the method may include overriding a name of a section with an original section name associated with one or more symbols, and at block 808, overriding a default origin name of the section with an origin module identifier associated with the one or more symbols.

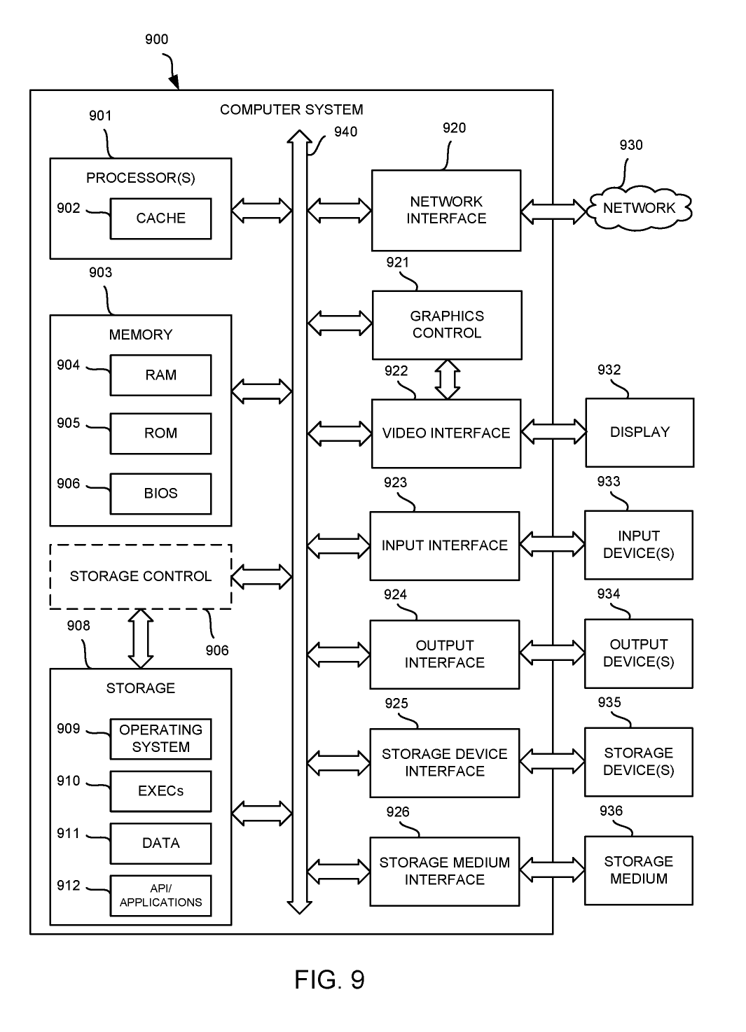

Referring next to FIG. 9, it is a block diagram depicting an exemplary machine that includes a computer system 900 within which a set of instructions can execute for causing a device to perform or execute any one or more of the aspects and/or methodologies for static code scheduling of the present disclosure. The components in FIG. 4 are examples only and do not limit the scope of use or functionality of any hardware, software, embedded logic component, or a combination of two or more such components implementing particular embodiments.

Computer system 900 may include a processor 901, a memory 903, and a storage 908 that communicate with each other, and with other components, via a bus 940. The bus 940 may also link a display 932, one or more input devices 933 (which may, for example, include a keypad, a keyboard, a mouse, a stylus, etc.), one or more output devices 934, one or more storage devices 935, and various tangible storage media 936. All of these elements may interface directly or via one or more interfaces or adaptors to the bus 940. For instance, the various tangible storage media 936 can interface with the bus 940 via storage medium interface 926. Computer system 900 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 901 (or central processing unit(s) (CPU(s))) optionally contains a cache memory unit 902 for temporary local storage of instructions, data, or computer addresses. Processor(s) 901 are configured to assist in execution of computer readable instructions. Computer system 900 may provide functionality for the components depicted in FIG. 1 as a result of the processor(s) 901 executing non-transitory, processor-executable instructions embodied in one or more tangible computer-readable storage media, such as memory 903, storage 908, storage devices 935, and/or storage medium 936. The computer-readable media may store software that implements particular embodiments, and processor(s) 901 may execute the software. Memory 903 may read the software from one or more other computer-readable media (such as mass storage device(s) 935, 936) or from one or more other sources through a suitable interface, such as network interface 920. The software may cause processor(s) 901 to carry out one or more processes or one or more steps of one or more processes described or illustrated herein. Carrying out such processes or steps may include defining data structures stored in memory 903 and modifying the data structures as directed by the software.

The memory 903 may include various components (e.g., machine readable media) including, but not limited to, a random access memory component (e.g., RAM 904) (e.g., a static RAM “SRAM”, a dynamic RAM “DRAM, etc.), a read-only component (e.g., ROM 905), and any combinations thereof. ROM 905 may act to communicate data and instructions unidirectionally to processor(s) 901, and RAM 904 may act to communicate data and instructions bidirectionally with processor(s) 901. ROM 905 and RAM 904 may include any suitable tangible computer-readable media described below. In one example, a basic input/output system 906 (BIOS), including basic routines that help to transfer information between elements within computer system 900, such as during start-up, may be stored in the memory 903.

Fixed storage 908 is connected bidirectionally to processor(s) 901, optionally through storage control unit 907. Fixed storage 908 provides additional data storage capacity and may also include any suitable tangible computer-readable media described herein. Storage 908 may be used to store operating system 909, EXECs 910 (executables), data 911, API applications 912 (application programs), and the like. Often, although not always, storage 908 is a secondary storage medium (such as a hard disk) that is slower than primary storage (e.g., memory 903). Storage 908 can also include an optical disk drive, a solid-state memory device (e.g., flash-based systems), or a combination of any of the above. Information in storage 908 may, in appropriate cases, be incorporated as virtual memory in memory 903.

In one example, storage device(s) 935 may be removably interfaced with computer system 900 (e.g., via an external port connector (not shown)) via a storage device interface 925. Particularly, storage device(s) 935 and an associated machine-readable medium may provide nonvolatile and/or volatile storage of machine-readable instructions, data structures, program modules, and/or other data for the computer system 900. In one example, software may reside, completely or partially, within a machine-readable medium on storage device(s) 935. In another example, software may reside, completely or partially, within processor(s) 901.

Bus 940 connects a wide variety of subsystems. Herein, reference to a bus may encompass one or more digital signal lines serving a common function, where appropriate. Bus 940 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 900 may also include an input device 933. In one example, a user of computer system 900 may enter commands and/or other information into computer system 900 via input device(s) 933. Examples of an input device(s) 933 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 933 may be interfaced to bus 940 via any of a variety of input interfaces 923 (e.g., input interface 923) including, but not limited to, serial, parallel, game port, USB, FIREWIRE, THUNDERBOLT, or any combination of the above.

In particular embodiments, when computer system 900 is connected to network 930, computer system 900 may communicate with other devices, specifically mobile devices and enterprise systems, connected to network 930. Communications to and from computer system 900 may be sent through network interface 920. For example, network interface 920 may receive incoming communications (such as requests or responses from other devices) in the form of one or more packets (such as Internet Protocol (IP) packets) from network 930, and computer system 900 may store the incoming communications in memory 903 for processing. Computer system 900 may similarly store outgoing communications (such as requests or responses to other devices) in the form of one or more packets in memory 903 and communicated to network 930 from network interface 920. Processor(s) 901 may access these communication packets stored in memory 903 for processing.

Examples of the network interface 920 include, but are not limited to, a network interface card, a modem, and any combination thereof. Examples of a network 930 or network segment 930 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 930, may employ a wired and/or a wireless mode of communication. In general, any network topology may be used.

Information and data can be displayed through a display 932. Examples of a display 932 include, but are not limited to, a liquid crystal display (LCD), an organic liquid crystal display (OLED), a cathode ray tube (CRT), a plasma display, and any combinations thereof. The display 932 can interface to the processor(s) 901, memory 903, and fixed storage 908, as well as other devices, such as input device(s) 933, via the bus 940. The display 932 is linked to the bus 940 via a video interface 922, and transport of data between the display 932 and the bus 940 can be controlled via the graphics control 921.

In addition to a display 932, computer system 900 may include one or more other peripheral output devices 934 including, but not limited to, an audio speaker, a printer, and any combinations thereof. Such peripheral output devices may be connected to the bus 940 via an output interface 924. Examples of an output interface 924 include, but are not limited to, a serial port, a parallel connection, a USB port, a FIREWIRE port, a THUNDERBOLT port, and any combinations thereof.

In addition or as an alternative, computer system 900 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for placing local symbols in an executable during link-time optimization of software code in the presence of a linker script, the method comprising:
determining an original output section for one or more symbols;
storing original section metadata for each of the one or more symbols in association with intermediate representations of the one or more symbols;
determining an origin module identifier that identifies a source file for each of the one or more symbols;
storing origin module identifier metadata for each of the one or more symbols;
emitting each of the one or more symbols to one or more output sections based on the original section metadata and the origin module identifier metadata;
extracting the original section metadata and origin module identifier metadata from the one or more symbols emitted to the one or more output sections;
overriding a name of a section with an original section name associated with the one or more symbols; and
overriding a default origin name of the executable section with an origin module identifier associated with the one or more symbols.

2. The method of claim 1, wherein said determining the original output section is based on one or more of:
command line flags;
source code annotations; and
conventions of a target backend.

3. The method of claim 1, further comprising:
ensuring that resolved section metadata, the original section metadata, and the origin module identifier metadata remains intact during optimization.

4. The method of claim 1, wherein emitting each of the one or more symbols to one or more output sections further comprises:
emitting each global symbol to one of:
a unique Extensible and Linkable Format (ELF) section of a required name according to the source file; and
a unique ELF section of a required name according to a particular symbol.

5. The method of claim 1, emitting each of the one or more symbols to one or more output sections further comprises:
emitting each symbol while communicating to a linker the original section and the origin module identifier of each local symbol.

6. The method of claim 5, further comprising:
emitting each symbol to a section having a name comprising a particular local symbol's original section and origin module identifier separated by a token known to the linker.

7. The method of claim 5, further comprising:
emitting each symbol to a unique ELF section having a name that is the same as the original section name according to the input file; and
emitting a special section that comprises a table with a mapping from ELF section IDs to the origin module identifiers of each symbol.

8. A computing device comprising a processor and a memory configured to execute:
a linker; and
a compiler,
wherein the linker and compiler are configured to perform a method for placing local symbols in an executable during link-time optimization of software code in the presence of a linker script, the method comprising:
determining an original output section for one or more symbols;
storing original section metadata for each of the one or more symbols in association with intermediate representations of the one or more symbols;
determining an origin module identifier that identifies a source file for each of the one or more symbols;
storing origin module identifier metadata for each of the one or more symbols;
emitting each of the one or more symbols to one or more output sections based on the original section metadata and the origin module identifier metadata;
extracting the original section metadata and origin module identifier metadata from the one or more symbols emitted to the one or more output sections;
overriding a name of a section with an original section name associated with the one or more symbols; and
overriding a default origin name of the executable section with an origin module identifier associated with the one or more symbols.

9. The computing device of claim 8, wherein said determining the original output section is based on one or more of:
command line flags;
source code annotations; and
conventions of a target backend.

10. The computing device of claim 8, further comprising:
ensuring that resolved section metadata, the original section metadata, and the origin module identifier metadata remains intact during optimization.

11. The computing device of claim 8, wherein emitting each of the one or more symbols to one or more output sections further comprises:
emitting each global symbol to one of:
a unique Extensible and Linkable Format (ELF) section of a required name according to the source file; and
a unique ELF section of a required name according to a particular symbol.

12. The computing device of claim 8, emitting each of the one or more symbols to one or more output sections further comprises:
emitting each symbol while communicating to a linker the original section and the origin module identifier of each local symbol.

13. The computing device of claim 12, further comprising:
emitting each symbol to a section having a name comprising a particular local symbol's original section and origin module identifier separated by a token known to the linker.

14. The computing device of claim 12, further comprising:
emitting each symbol to a unique ELF section having a name that is the same as the original section name according to the input file; and
emitting a special section that comprises a table with a mapping from ELF section IDs to the origin module identifiers of each symbol.

15. A non-transitory, tangible computer readable storage medium, encoded with processor readable instructions to perform a method for placing local symbols in an executable during link-time optimization of software code in the presence of a linker script, the method comprising:
determining an original output section for one or more symbols;
storing original section metadata for each of the one or more symbols in association with intermediate representations of the one or more symbols;
determining an origin module identifier that identifies a source file for each of the one or more symbols;
storing origin module identifier metadata for each of the one or more symbols;
emitting each of the one or more symbols to one or more output sections based on the original section metadata and the origin module identifier metadata;
extracting the original section metadata and origin module identifier metadata from the one or more symbols emitted to the one or more output sections;
overriding a name of a section with an original section name associated with the one or more symbols; and
overriding a default origin name of the executable section with an origin module identifier associated with the one or more symbols.

16. The non-transitory, tangible computer readable storage medium of claim 15, wherein said determining the original output section is based on one or more of:
command line flags;
source code annotations; and
conventions of a target backend.

17. The non-transitory, tangible computer readable storage medium of claim 15, further comprising:
ensuring that resolved section metadata, the original section metadata, and the origin module identifier metadata remains intact during optimization.

18. The non-transitory, tangible computer readable storage medium of claim 15, wherein emitting each of the one or more symbols to one or more output sections further comprises:
emitting each global symbol to one of:
a unique Extensible and Linkable Format (ELF) section of a required name according to the source file; and
a unique ELF section of a required name according to a particular symbol.

19. The non-transitory, tangible computer readable storage medium of claim 15, emitting each of the one or more symbols to one or more output sections further comprises:
emitting each symbol while communicating to a linker the original section and the origin module identifier of each local symbol.

20. The non-transitory, tangible computer readable storage medium of claim 19, further comprising:
emitting each symbol to a section having a name comprising a particular local symbol's original section and origin module identifier separated by a token known to the linker.
